(19) United States
(12) Patent Application Publication
(10) Pub. No.: US 2010/0097003 A1
(43) Pub. Date: Apr. 22, 2010

(54) HIGH-VOLTAGE DISCHARGE LAMP LIGHTING APPARATUS

(75) Inventors: Takafumi TODA, Nagaokakyo-shi (JP); Kengo MIYAZAKI, Kyoto-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: Murata Manufacturing Co., Ltd., Nagaokakyo-shi (JP)

(21) Appl. No.: 12/683,491

(22) Filed: Jan. 7, 2010

Related U.S. Application Data
(63) Continuation of application No. PCT/JP2008/056771, filed on Apr. 4, 2008.

(30) Foreign Application Priority Data
Jul. 9, 2007 (JP) 2007-179218

(51) Int. Cl. H05B 41/36

(52) U.S. Cl. 315/224

(57) ABSTRACT

In a high-voltage discharge lamp lighting apparatus for lighting a high-voltage discharge lamp, a digital control circuit synchronizes an ON/OFF state of a semiconductor switching element included in a step-down chopper circuit with an ON/OFF state of semiconductor switching elements included in an inverter circuit, and controls an ON time of the semiconductor switching element included in the step-down chopper circuit at the same or substantially the same time as a polarity reversal time in an alternating current waveform of the inverter circuit. As a result, in the high-voltage discharge lamp lighting apparatus in which rapid polarity reversal is required, the occurrence of overshoot and undershoot in the waveform of an alternating current passing through a high-voltage discharge lamp is reliably prevented.

### FIELD OF THE INVENTION

The present invention relates to a lighting apparatus for lighting a high-voltage discharge lamp used for a front projector.

### DESCRIPTION OF THE RELATED ART

For example, Japanese Unexamined Patent Application Publication No. 2004-220817 discloses a known high-voltage discharge lamp lighting apparatus. The high-voltage discharge lamp lighting apparatus disclosed in Japanese Unexamined Patent Application Publication No. 2004-220817 will be described with reference to FIGS. 1, 2A, and 2B. FIG. 1 is a circuit diagram of the high-voltage discharge lamp lighting apparatus. FIGS. 2A and 2B are waveform diagrams of each unit included in the high-voltage discharge lamp lighting apparatus.

In the high-voltage discharge lamp lighting apparatus illustrated in FIG. 1, an alternating voltage input from an alternating-current power supply AC is rectified by a rectifier circuit DB included in a direct-current power supply 1, converted into a direct voltage having a value greater than that of the input alternating voltage by a step-up chopper circuit CP1 and a smoothing circuit 2, and then output. The output direct voltage is converted into a direct voltage having a lower value by a step-down chopper circuit CP2 and is then output to a polarity reversal circuit 3. The polarity reversal circuit 3 is a full-bridge circuit including switching elements Q2 to Q5. The polarity reversal circuit 3 converts the direct voltage input from the step-down chopper circuit CP2 into an alternating voltage and supplies the alternating voltage to a high-voltage discharge lamp LA.

The switching elements Q2 to Q5 included in the full-bridge polarity reversal circuit 3 are driven by a driving circuit S. When the switching elements Q2 and Q5 are in an ON state, the switching elements Q3 and Q4 are turned off. When the switching elements Q2 and Q5 are in an OFF state, the switching elements Q3 and Q4 are turned on. As a result, an alternating voltage is generated. The driving circuit S is controlled by a control circuit MC including a measurement circuit 5. The control circuit MC also controls a step-up chopper control circuit CN1 and a step-down chopper control circuit CN2.

The invention disclosed in Japanese Unexamined Patent Application Publication No. 2004-220817 is configured to supply a voltage and a current which are capable of preventing the occurrence of overshoot at the time of polarity reversal to the high-voltage discharge lamp. In order to achieve this, the switching element Q2 is turned on/off at a frequency of several tens to several hundreds of Hz and the switching element Q5 that should be paired with the switching element Q2 is turned on/off at a frequency of several to several tens of kHz in the polarity reversal circuit 3. As a result, while the switching element Q2 is in the ON state, the switching element Q5 is repeatedly turned on/off. While the switching element Q4 is in the ON state, the switching element Q3 is similarly repeatedly turned on/off. Consequently, a sawtooth voltage and a sawtooth current illustrated in FIG. 2A are generated. Furthermore, by linearly or non-linearly changing the duty ratio of the step-down chopper circuit CP2, sawtooth wave peak values in periods corresponding to periods A and B illustrated in FIG. 2A are reduced. Such a voltage waveform and such a current waveform are input into the high-voltage discharge lamp LA as a trapezoidal wave illustrated in FIG. 2B via a low-pass filter composed of an inductor L2 and a capacitor C5 which are included in a load circuit 4 or a low-pass filter composed of an inductor L3 and a capacitor C4 which are included in the load circuit 4.

However, in the high-voltage discharge lamp lighting method disclosed in Japanese Unexamined Patent Application Publication No. 2004-220817, a large-constant inductor and a large-constant capacitor which are capable of changing a sawtooth voltage waveform and a sawtooth current waveform to a trapezoidal voltage waveform and a trapezoidal current waveform are required. It is impossible to achieve rapid polarity reversal with such a trapezoidal voltage waveform and such a trapezoidal current waveform. That is, it is impossible to achieve polarity reversal at a speed on the order of several μs that is currently required for high-voltage discharge lamp lighting apparatuses.

### SUMMARY OF THE INVENTION

To overcome the problems described above, preferred embodiments of the present invention provide a high-voltage discharge lamp lighting apparatus which is capable of achieving polarity reversal at speeds that are currently required for high-voltage discharge lamp lighting apparatuses.

A high-voltage discharge lamp lighting apparatus according to a preferred embodiment of the present invention for lighting a high-voltage discharge lamp includes a DC-DC converter circuit arranged to convert a direct voltage input from a direct-current input power supply into a predetermined direct voltage, an output voltage detection circuit arranged to detect a voltage output from the DC-DC converter circuit, a DC-AC inverter circuit arranged to convert the voltage output from the DC-DC converter circuit into an alternating voltage having a predetermined frequency, a lamp current detection circuit arranged to detect a lamp current passing through the high-voltage discharge lamp, an igniter circuit arranged to apply to the high-voltage discharge lamp at the time of starting of lighting a voltage greater than that applied to the high-voltage discharge lamp in a steady lighting state, and a control circuit arranged to control the DC-DC converter circuit and the DC-AC inverter circuit. The DC-DC converter circuit and the DC-AC inverter circuit individually include semiconductor switching elements. The control circuit synchronizes an ON/OFF state of the semiconductor switching element included in the DC-DC converter circuit with an ON/OFF state of the semiconductor switching element included in the DC-AC inverter circuit, controls the DC-DC converter circuit and the DC-AC inverter circuit based on a value of the output voltage detected by the output voltage detection circuit and a value of the lamp current detected by the lamp current detection circuit, and controls an ON time of the semiconductor switching element included in the DC-DC converter circuit at the same or substantially the same time as a polarity reversal time in an alternating current waveform of the DC-AC inverter circuit.

In the high-voltage discharge lamp lighting apparatus, the DC-DC converter circuit is preferably a step-down chopper DC-DC converter circuit.

In the high-voltage discharge lamp lighting apparatus, the DC-AC inverter circuit is preferably a full-bridge inverter circuit.

In the high-voltage discharge lamp lighting apparatus, a digital signal processor (DSP) is preferably used as the control circuit.

In the high-voltage discharge lamp lighting apparatus, the control circuit preferably performs PWM control upon the DC-DC converter circuit.

In the high-voltage discharge lamp lighting apparatus, the control circuit preferably controls an on-duty of a PWM pulse applied to the semiconductor switching element included in the DC-DC converter circuit at the same or substantially the same time as the polarity reversal time in the alternating current waveform of the DC-AC inverter circuit.

In the high-voltage discharge lamp lighting apparatus, the control circuit preferably performs control processing so that a predetermined number of PWM pulses are not output to the semiconductor switching element included in the DC-DC converter circuit at the same or substantially the same time as the polarity reversal time in the alternating current waveform of the DC-AC inverter circuit.

In the high-voltage discharge lamp lighting apparatus, the control circuit preferably synchronizes the alternating current waveform of the DC-AC inverter circuit with switching of the semiconductor switching element included in the DC-DC converter circuit, and shifts a phase of a switching pulse for the semiconductor switching element included in the DC-DC converter circuit with respect to that of a switching pulse for the DC-AC inverter circuit.

According to various preferred embodiments of the present invention, in a high-voltage discharge lamp lighting apparatus including a DC-AC inverter arranged to perform polarity reversal at a speed on the order of several μs, it is possible to reliably prevent the occurrence of overshoot and undershoot over the entire range of a lamp voltage by synchronizing the switching time of a DC-DC converter disposed at a stage prior to the DC-AC inverter and the switching time of the DC-AC inverter and changing the ON time of the DC-DC converter at the same or substantially the same time as polarity reversal of the DC-AC inverter.

Other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a circuit block diagram of a high-voltage discharge lamp lighting apparatus disclosed in Japanese Unexamined Patent Application Publication No. 2004-220817.

FIGS. 2A and 2B are waveform diagrams of each unit included in the high-voltage discharge lamp lighting apparatus disclosed in Japanese Unexamined Patent Application Publication No. 2004-220817.

FIG. 3 is a circuit block diagram of a high-voltage discharge lamp lighting apparatus according to a first preferred embodiment of the present invention.

FIG. 4 is a waveform diagram of an alternating current applied to a high-voltage discharge lamp in a high-voltage discharge lamp lighting apparatus in the related art.

FIG. 5 is a waveform diagram of an alternating current applied to a high-voltage discharge lamp in an ideal high-voltage discharge lamp lighting apparatus.

FIGS. 6A and 6B are waveform diagrams of an alternating current applied to a high-voltage discharge lamp in a high-voltage discharge lamp lighting apparatus according to the first preferred embodiment of the present invention and a PWM pulse applied to a switching element Q11 included in a step-down chopper circuit 12.

FIGS. 7A and 7B are waveform diagrams of an alternating current applied to a high-voltage discharge lamp in a high-voltage discharge lamp lighting apparatus according to a second preferred embodiment of the present invention and a PWM pulse applied to a switching element Q11 included in a step-down chopper circuit 12.

FIGS. 8A and 8B are waveform diagrams of an alternating current applied to a high-voltage discharge lamp in a high-voltage discharge lamp lighting apparatus according to a third preferred embodiment of the present invention and a PWM pulse applied to the switching element Q11 included in the step-down chopper circuit 12.

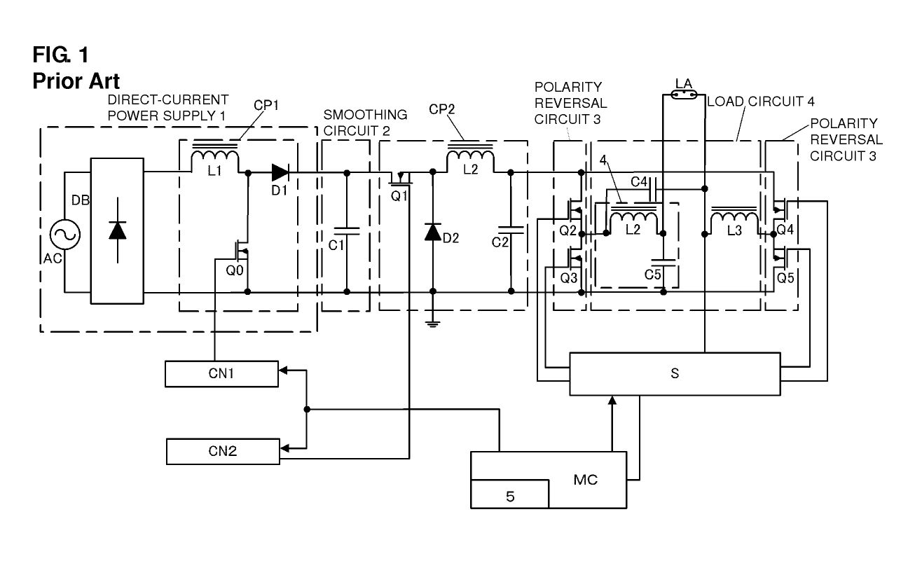

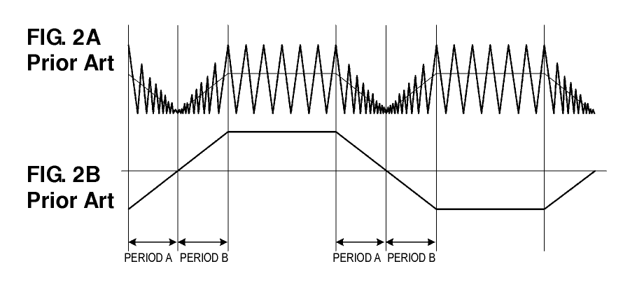

### DETAILED DESCRIPTION OF THE PREFERRED EMBODIMENTS

### First Preferred Embodiment

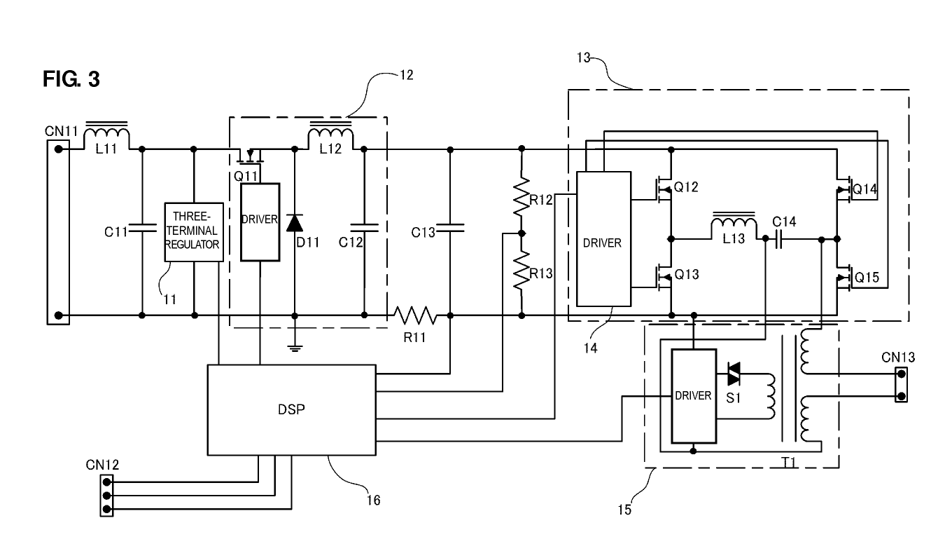

A first preferred embodiment of the present invention will be described with reference to FIGS. 3 to 6B. In FIG. 3, a direct voltage is input from a connector CN11. A low-pass filter including an inductor L11 and a capacitor C11 performs the stabilization and noise reduction of the input direct voltage, and is connected to a step-down chopper circuit 12, which defines a DC-DC converter circuit according to a preferred embodiment of the present invention, disposed at a subsequent stage. Since it is assumed that a high voltage is input in the first preferred embodiment, a step-down chopper circuit is used. However, when a low voltage is input, a step-up chopper circuit may be used. Alternatively, a step-up/step-down chopper circuit may be used as appropriate.

The step-down chopper circuit 12 includes a switching element Q11, a diode D11, an inductor L12, and a capacitor C12. The step-down chopper circuit 12 is a circuit arranged to step down the input direct voltage to a desired voltage value. The ON/OFF state of the switching element Q11 is controlled by a digital control circuit 16. As a result, the step-down chopper circuit 12 obtains a desired output voltage.

A voltage output from the step-down chopper circuit 12 is smoothed by a capacitor C13 and is then divided by resistors R12 and R13. A divided voltage is input into the digital control circuit 16. This circuit portion corresponds to an output voltage detection circuit.

As a result, the digital control circuit 16 can monitor a voltage output from the step-down chopper circuit 12 and perform control processing so as to obtain a constant or substantially constant output voltage.

A three-terminal regulator 11 disposed at a stage prior to the step-down chopper circuit 12 is preferably used to generate a power supply voltage for the digital control circuit 16. A voltage output from the three-terminal regulator 11 is used as a power supply voltage for the digital control circuit 16.

The direct voltage output from the step-down chopper circuit 12 is supplied to a polarity reversal circuit 13, which defines a DC-AC inverter circuit according to a preferred embodiment of the present invention, disposed at a subsequent stage.

The polarity reversal circuit 13 is preferably a full-bridge circuit including four switching elements, switching elements Q12 to Q15, an inductor L13, a capacitor C14, and a driver 14 arranged to drive the switching elements Q12 to Q15. In this preferred embodiment, although a full-bridge circuit is used as the polarity reversal circuit 13, a half-bridge circuit or a push-pull circuit may be used as the polarity reversal circuit 13 where appropriate.

The driver 14 complementarily turns on/off a pair of the switching elements Q12 and Q15 and a pair of the switching elements Q13 and Q14 in response to an instruction signal transmitted from the digital control circuit 16 so as to convert the direct voltage into an alternating voltage. The generated alternating voltage is supplied to a high-voltage discharge lamp connected to a connector CN13.

On an alternating voltage output line extending to the connector CN13, an igniter circuit 15 including a bidirectional two-terminal thyristor S1 and a transformer T1 is provided. In general, high-voltage discharge lamps light up only when a significantly high voltage is applied thereto. Once such a high-voltage discharge lamp lights up, the lamp stays on at a relatively low voltage. Accordingly, in order to instantaneously apply a high voltage to the high-voltage discharge lamp at the time of starting of lighting, an instruction signal is transmitted from the digital control circuit 16 to the bidirectional two-terminal thyristor S1 so that the bidirectional two-terminal thyristor S1 is instantaneously turned on and generates a voltage greater than that generated in a steady lighting state.

A lamp current passing through the high-voltage discharge lamp corresponding to a load is monitored by the digital control circuit 16 when a resistor R11 functions as a current detection resistor. This circuit portion corresponds to a lamp current detection circuit according to a preferred embodiment of the present invention.

A connector CN12 connected to the digital control circuit 16 is preferably used as the connection to a microcomputer or other suitable device in an apparatus such as a front projector. It is possible to check the operation state of the high-voltage discharge lamp lighting apparatus and input an instruction signal to set an output voltage or an output current into the high-voltage discharge lamp lighting apparatus via the connector CN12.

The digital control circuit 16 performs the collective management of an instruction to turn on/off the switching element Q11 included in the step-down chopper circuit 12, an instruction to cause the driver 14 to control the ON/OFF state of the switching elements Q12 to Q15 included in the polarity reversal circuit 13, an instruction to the igniter circuit 15 at the starting of lighting, and other instructions based on an output voltage value of the step-down chopper circuit 12 detected by the resistors R12 and R13, a value of an alternating current passing through the high-voltage discharge lamp which is detected by the resistor R11, an instruction received from the apparatus via the connector CN12, and other parameters.

The digital control circuit 16 performs constant power control based on a value of a voltage output from the step-down chopper circuit 12 and a value of an alternating current passing through the high-voltage discharge lamp so that the high-voltage discharge lamp stays on at a predetermined brightness level in a steady lighting state. That is, the digital control circuit 16 adjusts the value of the voltage output from the step-down chopper circuit 12 and the value of the alternating current passing through the high-voltage discharge lamp so that the product thereof (output power) is constant or substantially constant. Furthermore, the digital control circuit 16 prevents overshoot and undershoot of a current passing through the high-voltage discharge lamp by performing control processing to be described later.

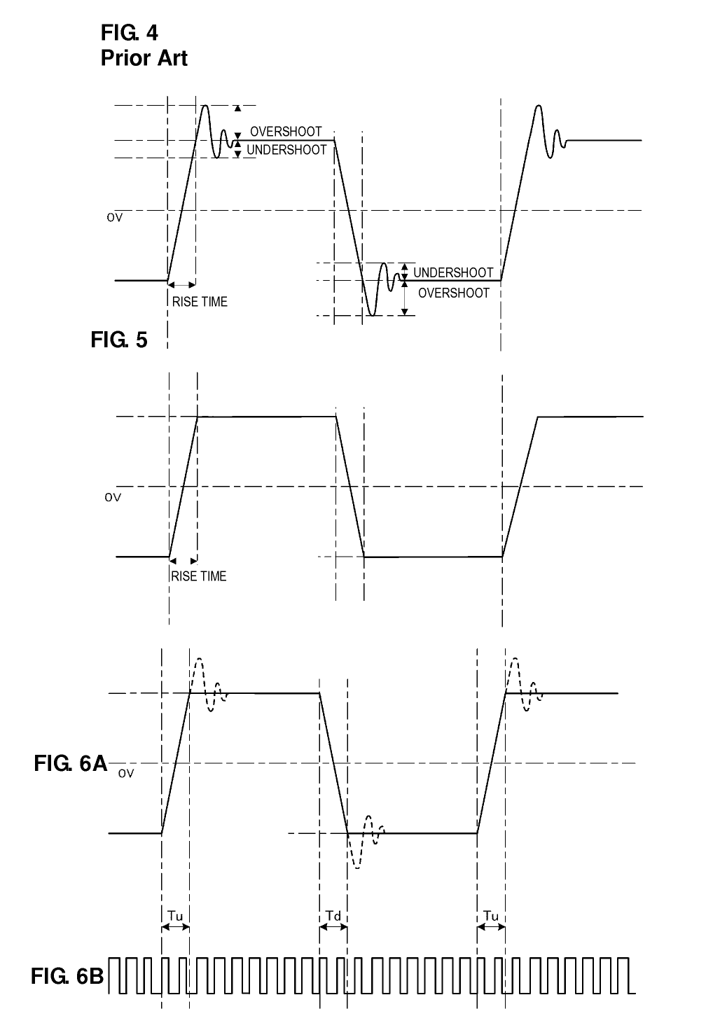

In the circuit illustrated in FIG. 3, when processing to control a voltage output from the step-down chopper circuit and processing to control the generation of an alternating voltage performed by the polarity reversal circuit 13 are separately performed, a current having an alternating current waveform illustrating FIG. 4 passes through the high-voltage discharge lamp that is a load. Here, the frequency of an alternating voltage applied to the high-voltage discharge lamp is about 50 Hz to about 500 Hz, for example.

In recent high-voltage discharge lamp lighting apparatuses used for front projectors, it is necessary to achieve a steep rise/fall time (for example, a time equal to or less than about 2 μs) at the time of polarity reversal and to prevent the occurrence of overshoot and undershoot in a voltage waveform and a current waveform. If the shortening of a rise/fall time at the time of polarity reversal is performed, the prevention of the occurrence of overshoot and undershoot cannot be effectively achieved.

The shortening of a rise/fall time at the time of polarity reversal produces a flicker of a high-voltage discharge lamp, and overshoot and undershoot in a voltage waveform and a current waveform reduce the life of the high-voltage discharge lamp. It is therefore preferable that both a steep rise/fall time at the time of polarity reversal and prevention of the occurrence of overshoot and undershoot in a voltage waveform and a current waveform be achieved as in the waveform illustrated in FIG. 5.

The reason that overshoot and undershoot occur at the time of polarity reversal is that a high-voltage discharge lamp is brought into an unloaded condition at the instant of the polarity reversal when viewed from the step-down chopper circuit 12. That is, an output voltage instantaneously jumps at the time of the polarity reversal, and overshoot and undershoot therefore occur.

In order to prevent such a phenomenon, in a preferred embodiment of the present invention, the digital control circuit 16 controls the ON time of the switching element Q11 included in the step-down chopper circuit 12 at the instant of the polarity reversal of the polarity reversal circuit 13 so as to reduce an on-duty of the switching element Q11 in the circuit illustrated in FIG. 3. As a result, energy applied to a load is reduced, and the occurrence of overshoot and undershoot is prevented.

FIGS. 6A and 6B are diagrams illustrating an effect obtained from the reduction in an on-duty. FIG. 6A is a waveform diagram of an alternating current applied to a high-voltage discharge lamp. FIG. 6B is a waveform diagram of a PWM pulse applied to the switching element Q11 included in the step-down chopper circuit 12. As illustrated in FIGS. 6A and 6B, by reducing the on-duty of the switching element Q11 included in the step-down chopper circuit 12 at the instant of polarity reversal of the polarity reversal circuit 13 (in periods represented by Tu and Td), the occurrence of overshoot and undershoot is prevented.

At that time, in order to reliably prevent the occurrence of overshoot and undershoot, the switching time of the switching elements Q12 to Q15 included in the polarity reversal circuit 13 and the switching time of the switching element Q11 included in the step-down chopper circuit 12 must be synchronized with each other. In the first preferred embodiment, the digital control circuit 16 preferably controls not only the switching element Q11 included in the step-down chopper circuit 12 but also the switching elements Q12 to Q15 included in the polarity reversal circuit 13, thereby synchronizing them.

The digital control circuit 16 continuously monitors a voltage output from the step-down chopper circuit 12 and a lamp current value. When the high-voltage discharge lamp is changed from a non-operation state to a glow discharging state, the impedance and the output voltage of the step-down chopper circuit 12 are rapidly reduced. After the rapid reduction in the output voltage of the step-down chopper circuit 12 has been detected, the on-duty of the step-down chopper circuit 12 is reduced. Accordingly, the manner of setting the on-duty of the step-down chopper circuit 12 based on the range of decrease in the output voltage value of the step-down chopper circuit 12 per unit time or the range of increase in a lamp current value is programmed in advance.

The levels of overshoot and undershoot are preferably estimated immediately before polarity reversal based on a detected lamp voltage value and/or a detected lamp current value, and the ON time of the DC-DC converter is changed at the same or substantially the same time as the polarity reversal. Consequently, it is possible to reliably prevent the occurrence of overshoot and undershoot over the entire or substantially the entire range of a lamp voltage.

It is preferable that a digital signal processor (DSP) be used as the digital control circuit 16, for example. Although a microcomputer or other device may be used as the digital control circuit 16, it is preferable that a DSP be used as the digital control circuit 16 due to the increased processing speed.

Furthermore, it is preferable that PWM control be performed on the switching element Q11 included in the step-down chopper circuit 12 in response to an ON/OFF instruction signal output from the digital control circuit 16. When the PWM control is performed on the switching element Q11, the switching frequency of the switching element Q11 is fixed. Accordingly, by setting the switching frequency of the switching element Q11 so that it is an integer multiple of that of the switching elements Q12 to Q15 included in the polarity reversal circuit 13, it is possible to reliably synchronize the switching time of the switching element Q11 and the switching time of the switching elements Q12 to Q15 included in the polarity reversal circuit 13. At that time, as described previously, by reducing the on-duty of the switching element Q11 at the same or substantially the same time as polarity reversal, it is possible to effectively prevent the occurrence of overshoot and undershoot in an alternating voltage waveform and an alternating current waveform at the time of the polarity reversal.

### Second Preferred Embodiment

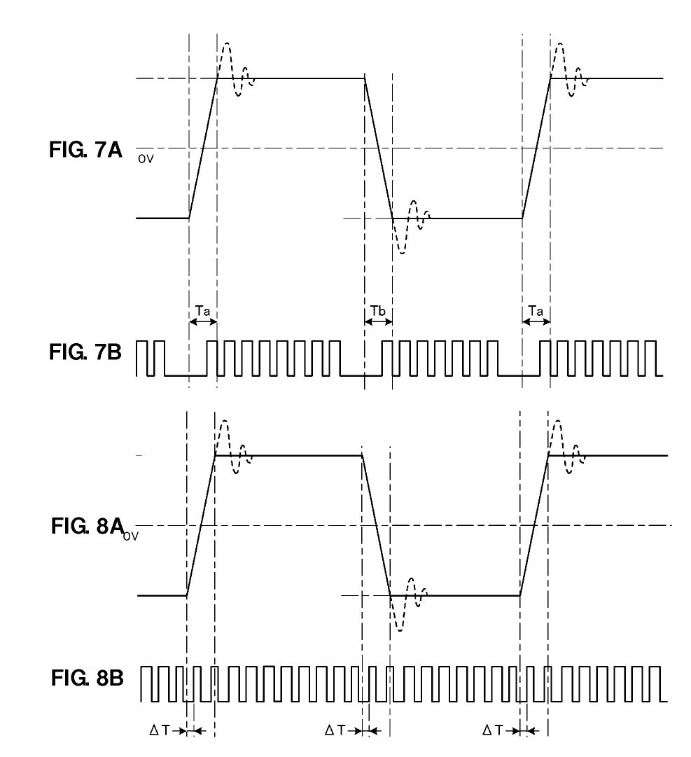

Next, a second preferred embodiment of the present invention will be described with reference to FIGS. 3, 7A, and 7B. In the first preferred embodiment, by synchronizing the switching time of the switching element Q11 and the switching time of the switching elements Q12 to Q15 and reducing the on-duty of the switching element Q11, the occurrence of overshoot and undershoot in the waveform of an alternating current applied from the polarity reversal circuit 13 to the high-voltage discharge lamp is prevented. In the second preferred embodiment, the switching time of the switching element Q11 and the switching time of the switching elements Q12 to Q15 are synchronized with each other, and control processing is performed so that an ON/OFF instruction signal is not output from the digital control circuit 16 to the switching element Q11 at the same or substantially the same time as the polarity reversal of the polarity reversal circuit 13.

FIGS. 7A and 7B are diagrams illustrating an operational effect of the second preferred embodiment. FIG. 7A is a waveform diagram of an alternating current applied to a high-voltage discharge lamp. FIG. 7B is a waveform diagram of a PWM pulse applied to the switching element Q11 included in the step-down chopper circuit 12. As illustrated in FIGS. 7A and 7B, an ON/OFF instruction signal is not output from the digital control circuit 16 to the switching element Q11 at the same or substantially the same time as the polarity reversal of the polarity reversal circuit 13 (in periods represented by Ta and Tb). As a result, a predetermined number of PWM pulses are not output, a PWM pulse period in which an on-duty is zero is generated, and energy supplied to the polarity reversal circuit is reduced. Consequently, the occurrence of overshoot and undershoot is effectively prevented.

Thus, in the second preferred embodiment, a method is performed to control the number of times a switching pulse for the step-down chopper circuit 12 is eliminated by preventing the digital control circuit 16 from outputting an ON/OFF instruction signal to the switching element Q11. Accordingly, the digital control circuit 16 continuously monitors a voltage output from the step-down chopper circuit 12 and a lamp current value. When the voltage output from the step-down chopper circuit 12 sharply drops, the digital control circuit 16 detects that the high-voltage discharge lamp has been changed from a non-operation state to a glow discharging state and controls the number of times a switching pulse for the step-down chopper circuit 12 is eliminated. Accordingly, the manner of setting the number of times a switching pulse for the step-down chopper circuit 12 is eliminated based on the range of decrease in the output voltage value of the step-down chopper circuit 12 per unit time or the range of increase in a lamp current value is programmed in advance.

The levels of overshoot and undershoot are preferably estimated immediately before polarity reversal based on a detected lamp voltage value and/or a detected lamp current value, and the ON time of the DC-DC converter is changed at the same or substantially the same time as the polarity reversal. Consequently, it is possible to reliably prevent the occurrence of overshoot and undershoot over the entire range of a lamp voltage.

### Third Preferred Embodiment

Next, a third preferred embodiment of the present invention will be described with reference to FIGS. 3, 8A, and 8B.

In the third preferred embodiment, the timing (phase) of a switching pulse for the switching element Q11 included in the step-down chopper circuit 12 is shifted with respect to that of a switching pulse for the polarity reversal circuit 13.

FIGS. 8A and 8B are diagrams illustrating an operational effect obtained from the shortening of an on-duty. FIG. 8A is a waveform diagram of an alternating current applied to a high-voltage discharge lamp. FIG. 8B is a waveform diagram of a PWM pulse applied to the switching element Q11 included in the step-down chopper circuit 12. As illustrated in FIGS. 8A and 8B, the timing (phase) of a switching pulse for the switching element Q11 included in the step-down chopper circuit 12 is shifted with respect to that of a switching pulse for the polarity reversal circuit 13, and they are synchronized with each other in that state.

When a voltage is applied to a high-voltage discharge lamp in the non-operation state of the high-voltage discharge lamp, a breakdown occurs, glow discharging starts, and the impedance of the lamp sharply falls. When energy is excessively supplied from a step-down chopper to the high-voltage discharge lamp in the low impedance state, overshoot and undershoot occur. Accordingly, in the low impedance state, a circuit is required to operate so that energy is not excessively supplied from the step-down chopper to the high-voltage discharge lamp. In some high-voltage discharge lamps that are loads, energy is not be excessively supplied from a step-down chopper to the high-voltage discharge lamp in accordance with the difference between the switching time of the step-down chopper circuit 12 and the time of polarity reversal of the polarity reversal circuit 13.

Therefore, in the third preferred embodiment, in accordance with the property of a high-voltage discharge lamp, the timing (phase) of a switching pulse for the switching element Q11 included in the step-down chopper circuit 12 is preferably shifted with respect to that of a switching pulse for the polarity reversal circuit 13 by ΔT. As a result, the occurrence of overshoot and undershoot in the waveform of an alternating current is effectively prevented.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A high-voltage discharge lamp lighting apparatus for lighting a high-voltage discharge lamp, the high-voltage discharge lamp lighting apparatus comprising:
a DC-DC converter circuit arranged to convert a direct voltage input from a direct-current input power supply into a predetermined direct voltage;
an output voltage detection circuit arranged to detect a voltage output from the DC-DC converter circuit;
a DC-AC inverter circuit arranged to convert the voltage output from the DC-DC converter circuit into an alternating voltage having a predetermined frequency;
a lamp current detection circuit arranged to detect a lamp current passing through the high-voltage discharge lamp;
an igniter circuit arranged to apply to the high-voltage discharge lamp, at a time of starting of lighting, a voltage greater than that applied to the high-voltage discharge lamp in a steady lighting state; and
a control circuit arranged to control the DC-DC converter circuit and the DC-AC inverter circuit; wherein
each of the DC-DC converter circuit and the DC-AC inverter circuit includes a semiconductor switching element; and
the control circuit is programmed to synchronize an ON/OFF state of the semiconductor switching element included in the DC-DC converter circuit with an ON/OFF state of the semiconductor switching element included in the DC-AC inverter circuit, to control the DC-DC converter circuit and the DC-AC inverter circuit based on a value of the output voltage detected by the output voltage detection circuit and a value of the lamp current detected by the lamp current detection circuit, and to control an ON time of the semiconductor switching element included in the DC-DC converter circuit at the same or substantially the same time as a polarity reversal time in an alternating current waveform of the DC-AC inverter circuit.

2. The high-voltage discharge lamp lighting apparatus according to claim 1, wherein the DC-DC converter circuit includes a step-down chopper DC-DC converter circuit.

3. The high-voltage discharge lamp lighting apparatus according to claim 1, wherein the DC-AC inverter circuit includes a full-bridge inverter circuit.

4. The high-voltage discharge lamp lighting apparatus according to claim 1, wherein a digital signal processor is included in the control circuit.

5. The high-voltage discharge lamp lighting apparatus according to claim 1, wherein the control circuit is programmed to perform PWM control on the DC-DC converter circuit.

6. The high-voltage discharge lamp lighting apparatus according to claim 5, wherein the control circuit is programmed to control an on-duty of a PWM pulse applied to the semiconductor switching element included in the DC-DC converter circuit at the same or substantially the same time as the polarity reversal time in the alternating current waveform of the DC-AC inverter circuit.

7. The high-voltage discharge lamp lighting apparatus according to claim 5, wherein the control circuit is programmed to perform control processing so that a predetermined number of PWM pulses are not output to the semiconductor switching element included in the DC-DC converter circuit at the same or substantially the same time as the polarity reversal time in the alternating current waveform of the DC-AC inverter circuit.

8. The high-voltage discharge lamp lighting apparatus according to claim 5, wherein the control circuit is programmed to synchronize the alternating current waveform of the DC-AC inverter circuit with switching of the semiconductor switching element included in the DC-DC converter circuit, and to shift a phase of a switching pulse for the semiconductor switching element included in the DC-DC converter circuit with respect to that of a switching pulse for the DC-AC inverter circuit.
